(19) United States
(12) Patent Application Publication
(10) Pub. No.: US 2011/0117524 A1
(43) Pub. Date: May 19, 2011

(54) UNIVERSAL DENTAL CROWN AND SYSTEM AND METHOD OF RESTORING A TOOTH USING A UNIVERSAL DENTAL CROWN

(75) Inventors: Simon Paul McDonald, Katikati (NZ); Adam Doudney, Auckland (NZ)

(73) Assignee: Tri-Dent Innovations Limited, Katikati (NZ)

(21) Appl. No.: 12/847,782

(22) Filed: Jul. 30, 2010

(30) Foreign Application Priority Data
Nov. 16, 2009 (NZ) 581203

(51) Int. Cl. A61C 5/11; A61C 5/10

(52) U.S. Cl. 433/219; 433/218

(57) ABSTRACT

The present invention relates to dental crowns for use in restoring a prepared tooth wherein the dental crown comprises a universally sized crown shell and crown matrix to enable the sizing and fitting of the dental crown to the patient in a single sitting and without an impression or laboratory procedure.

### FIELD OF THE INVENTION

The present invention relates to a universal dental crown and system that enables a dental professional to create and bond a dental crown in place without an impression or laboratory procedure.

### BACKGROUND OF THE INVENTION

Traditionally, porcelain or ceramic dental crowns have been made by a dental technician using a model of the tooth that was cast from an impression. This process generates very accurate and successful crowns but the process is costly and requires at least two patient visits with a gap between, with sufficient time for the dental technician to complete the laboratory work.

More recently, a CAD/CAM process has been developed whereby digital data from a 3D scan of the tooth is imported into a CAD/CAM program and a ceramic crown is designed and milled from a block of material using a sophisticated CNC milling machine. The alternative to a porcelain or ceramic crown for a patient with limited financial means is a composite resin crown. These are ordinarily created directly in the mouth and are awkward for the dental professional to create and are more likely to fracture or otherwise fail.

### SUMMARY OF THE INVENTION

It is an object of the present invention to provide dentists and their patients with an alternative type of dental crown/restoration that is strong, easily fitted in one appointment and costs less than the laboratory or CAD/CAM crown. The present inventive crown addresses these goals, amongst others.

The dental crown according to the present invention for use in restoring a prepared tooth comprises a crown shell comprising a cavity for receiving a portion of the prepared tooth and an apical margin defining the bottom edge of the crown shell; and a crown matrix comprising an exterior surface configured to resemble a tooth and further configured to receive the crown shell wherein sidewalls of the crown matrix extend beyond the apical margin of the crown shell. The crown shell is received by the crown matrix and secured by friction fit. The sidewalls of the crown matrix extend beyond the apical margin of the crown shell by at least approximately 1 to 4 millimeters. The crown matrix if formed from a trimmable material having a thickness between 10 and 100 microns to enable the crown matrix to be trimmed to fit upon application of the dental crown to the prepared tooth.

The crown shell comprises a buccal surface, lingual surface, mesial surface and distal surface and an occlusal surface, the crown matrix interior surface comprises a buccal portion, a lingual portion, a mesial portion, a distal portion, and an occlusal portion and the crown matrix receives the entire crown shell. In another preferred embodiment of the present the crown shell comprises a buccal surface, lingual surface, mesial surface and distal surface and an occlusal surface and the crown matrix interior surface comprises a buccal portion, a lingual portion, a mesial portion, and a distal portion, wherein said portions engage less than that entire corresponding surface of the crown shell.

The crown matrix further comprises a perforation or thinned portion to promote tight fit of the dental crown with an adjacent tooth or adjacent crown. A first perforation or thinned portion is disposed on the mesial surface of the crown matrix and enables tight fit of a mesial surface of the dental crown with a distal surface of an adjacent tooth or adjacent crown. A first perforation or thinned portion may also be disposed on the distal surface of the crown matrix and enables tight fit of a distal surface of the dental crown with a mesial surface of an adjacent tooth or adjacent crown.

The crown matrix sidewall further comprises at least a first perforation or vent disposed in the sidewall in the portion extending beyond the apical margin of the crown shell, the perforation or vent facilitating escape of excess amounts of a bonding and filling agent used to affix the dental crown to the prepared tooth.

### BRIEF DESCRIPTION OF THE DRAWINGS

FIG. 1 is a partial perspective view of a universal dental crown according to a first embodiment of the present invention;

FIG. 2 is an elevation view of a universal dental crown according to a first embodiment of the present invention;

FIG. 3 is a partial perspective view of a universal dental crown according to a first embodiment of the present invention;

FIG. 4 is a partial perspective view of a universal dental crown according to a first embodiment of the present invention;

FIG. 5a is a partial perspective view of a universal dental crown according to a first embodiment of the present invention;

FIG. 5b is a partial perspective view of a universal dental crown according to a first embodiment of the present invention;

FIG. 6 is an elevation view of a universal dental crown according to a first embodiment of the present invention;

FIG. 7 is a perspective view of a universal dental crown according to a second embodiment of the present invention;

FIG. 8 is a perspective view of a universal dental crown according to a second embodiment of the present invention,

FIG. 9 is a perspective view of a universal dental crown according to a second embodiment of the present invention;

FIG. 10 is a perspective view of a universal dental crown according to a third embodiment of the present invention; and

FIG. 11 is a perspective view of a universal dental crown according to a third embodiment of the present invention.

### DETAILED DESCRIPTION OF DRAWINGS

### 1. Definitions

Restoring a tooth is a method for returning a damaged tooth to its normal anatomy ensuring that the tooth is able to function in a normal manner.

A dental crown refers to an artificial ceramic or metal structure that sits on top of the damaged tooth to mimic a normal tooth.

A dental matrix refers to a mold that mimics the shape and size of a normal tooth.

The mesial surface refers to mid-line (or towards the front of the mouth) and the distal surface refers to the back surface of the tooth. The buccal and lingual sides are the cheek and tongue surfaces of the tooth, respectively. The occlusal surface is the biting or top surface of the tooth.

Restorative materials traditionally used to restore a damaged tooth include, but are not limited to: composite resin, cement, silver, gold, porcelain, amalgam, alloy, wax.

### 2. Description of Preferred Embodiments

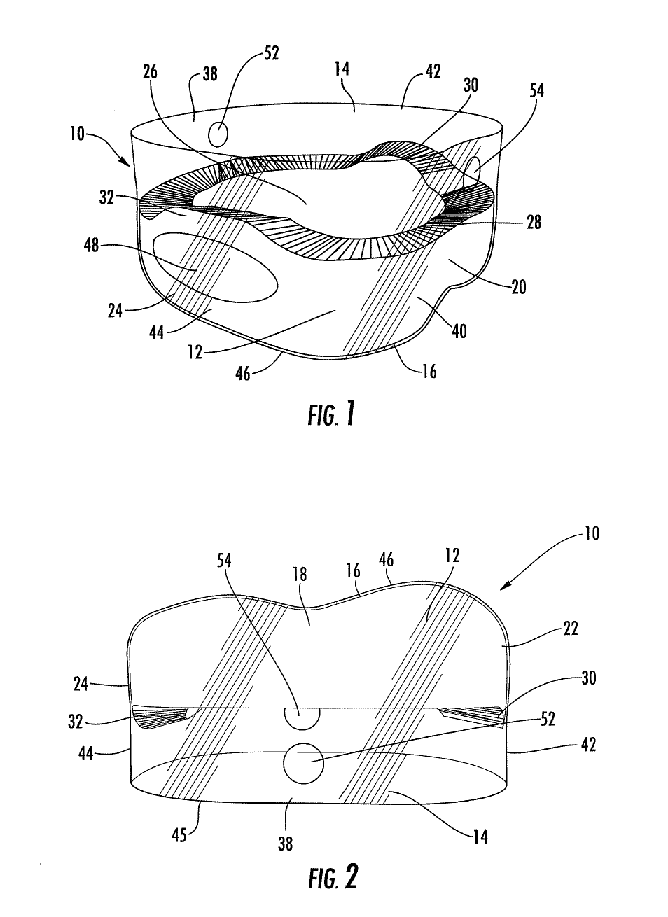

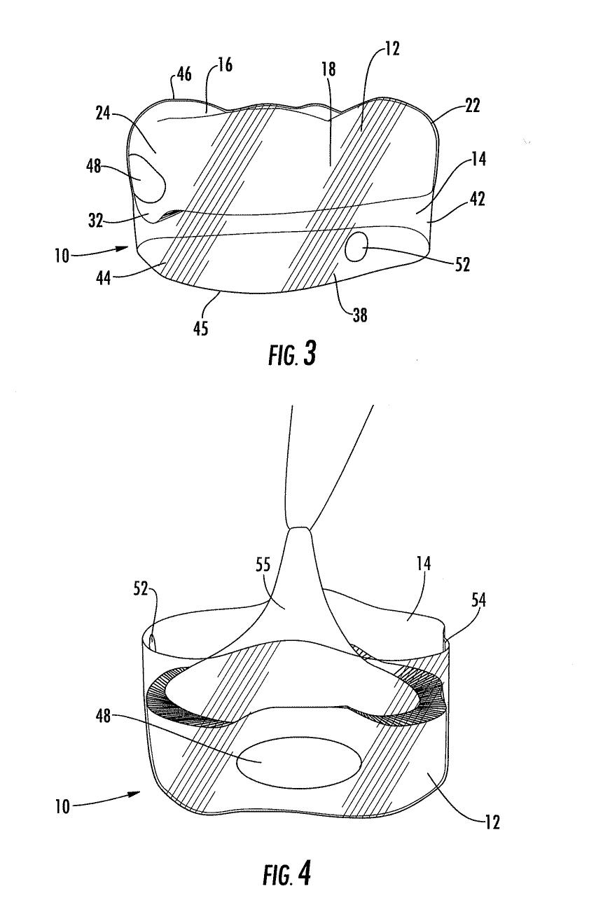

As shown in the attached figures, a dental crown 10 in accordance with the present invention comprises two primary components to form a single device. Referring specifically to the first embodiment of the present invention shown in FIGS. 1-3, the dental crown 10 comprises a crown shell 12 that is the inner component and a crown matrix 14 that is the outer component. The crown shell 12 is a universal component that is manufactured in a range of shades, tooth-types and sizes. The crown shell 12 is preferably composed of universal ceramic, metal, plastic or resin material formed using conventional means for working with these materials, such as plastic injection molding, pressing molten glass or injecting ceramic powders into molds and then consolidating the powders in a furnace. The crown shell 12 generally includes an occlusal surface 16 and side surfaces consisting of a buccal surface 18, lingual surface 20, distal surface 22, and mesial surface 24. FIG. 1 also shows an internal cavity 26 configured to receive a portion of the prepared tooth and the bonding and filling agent for bonding or adhering the crown shell 12 to the prepared tooth 36 (best seen in FIGS. 5a, 5b). The crown shell 12 comprises a lower edge or apical margin 28, a distal extension 30 and a mesial extension 32.

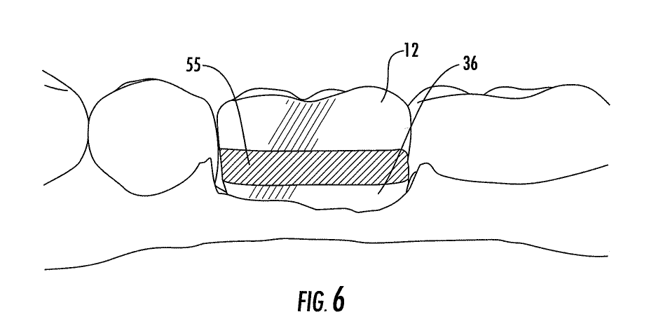

As shown in FIGS. 1-3, the tooth anatomy of the crown shell 12, namely, the circumferential dimensions and configuration of the occlusal surface 16, buccal surface 18, lingual surface 20, distal surface 22, and mesial surface 24, are selected to mimic the shapes and sizes of normal teeth in an adolescent or adult human. The crown shell 12 of the present invention is manufactured to provide a gap 34 of approximately 1 to 4 millimeters between the apical margin 28 of the crown shell and the prepared tooth 36 (best shown in FIG. 5b) when the occlusal surface 16 is positioned to correspond to the occlusal surfaces of adjacent teeth or crowns. The gap 34 accommodates any suitable adhesive or bonding and filling agent for joining the crown shell 12 and prepared tooth 36. In this configuration, the crown shell 12 of the present invention provides a complete occlusal surface 16, but only partially includes the buccal 18, lingual 20, distal 22, and mesial 24 surfaces, as best seen in FIGS. 5b and 6. The gap 34 provides for universal application of the crown shell 12, by not requiring a crown shell be an exact fit in the mouth of the patient. Rather, the dental professional can fit the crown to the patient in a single appointment.

The crown matrix 14 preferably consists of a thin plastic or metal foil, approximately 10-100 microns thick and intimately receives the entire crown shell 12 or a portion of the crown shell 12. The crown shell 12 and crown matrix 14 interface by friction fit or by adhesive to form a permanent or semi-permanent bond. The sidewalls of the crown matrix 14, which consist of buccal 38, lingual 40, distal 42, and mesial 44 portions, extend beyond the apical margin 28 of the crown shell 12 when the crown shell is received by the crown matrix 14, and terminate at a gingival edge 45. In the first embodiment of the present invention, the crown matrix 14 is configured similar to the crown shell 12 in that it comprises buccal 38, lingual 40, distal 42, and mesial 44 portions and an occlusal portion 46, with each portion having an internal surface that defines a cavity for receiving and encompassing the crown shell 12 in its entirety. In this embodiment, the exterior surfaces of the buccal 38, lingual 40, distal 42, mesial 44, and occlusal 46 portions, are configured to mirror the contours of a normal tooth, with these surfaces tapering towards the gingival margin 45.

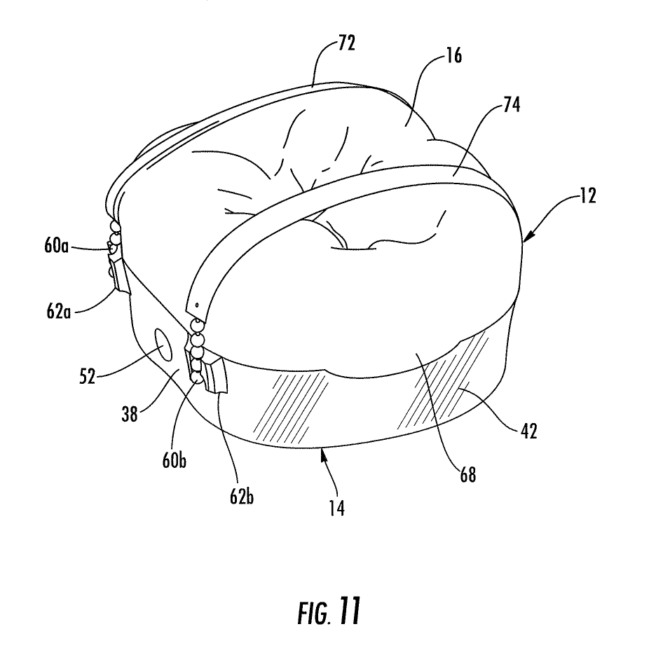

The crown matrix 14 can also be formed as a band comprising buccal 38, lingual 40, distal 42, and mesial 44 portions, but lacking an occlusal portion (best seen in FIGS. 10,11). The crown matrix 14 of this embodiment interfaces with portions of the buccal 18, lingual 20, distal 22, and mesial 24 surfaces of the crown shell 12 terminate at an upper margin 58, which is preferably below the interproximal points of contact between the distal and mesial surfaces 22, 24 of the crown shell 12 and adjacent teeth or crowns. In this configuration, the crown shell 12 may be integrated with the crown matrix 14 at the aperture formed by margin 58. The crown matrix 14 may also be set in place and the crown shell 12 removed for further refinement, adjustment or modification.

The crown matrix 14 shown in FIGS. 1, 3 and 4 also demonstrates incorporation of a perforation or thinned section 48 in the distal portion 42 (not shown) or mesial portion 44 of the crown matrix 14. The perforations or thinned sections 48 are placed at the anatomical contact points of the crown 10 with neighboring teeth or crowns. The perforations or thinned sections 48 enable the crown 10 to be fitted to establish the correct mesial and distal contacts without the crown matrix 14 interfering. This enables the dental professional preparing the crown 10 to create tight contact with neighboring teeth or crowns. As seen in FIGS. 1-4, the crown matrix 14 further comprises one or more perforations or vents 52, 54 in the sidewall on the buccal portion 38 and/or lingual portion 40 of the crown-matrix 14. The perforations or vents 52, 54 enables excess bonding and filling agent to escape during installation of the crown 10. The perforations or vents 52, 54 also enable the dental professional to work any air bubbles out of the bonding and filling agent to ensure a maximum amount of bonding and filling agent per volume available is utilized.

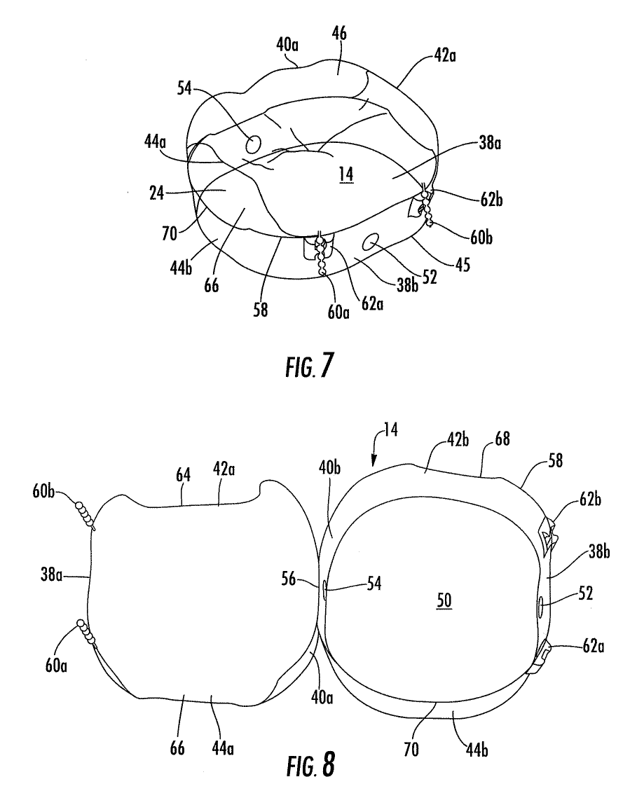

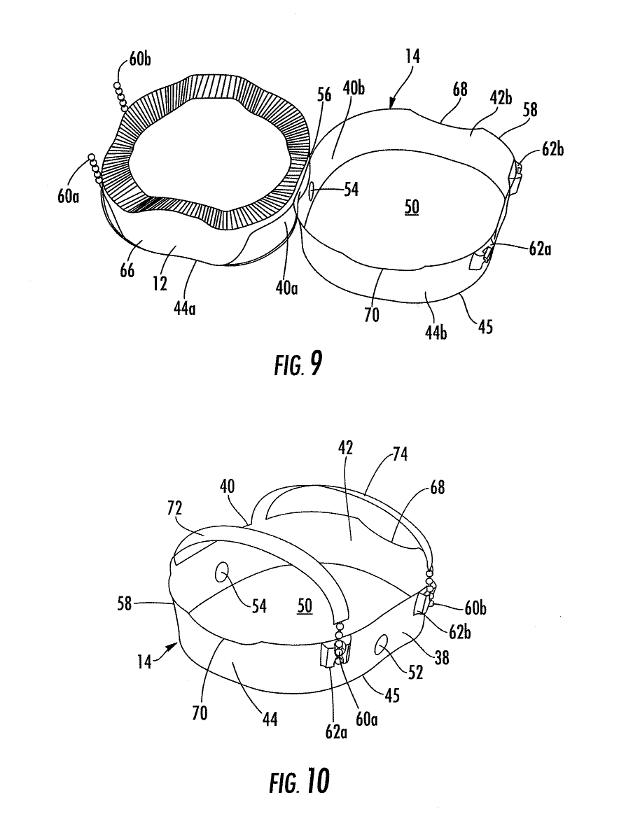

FIGS. 7-9 show a second embodiment of the present invention where the crown matrix 14 includes a hinged portion 56 enabling the occlusal surface 46 and portions of the buccal 38a, lingual 40a, distal 42a and mesial 44a surface to rotate about the hinged portion 56 exposing the internal cavity of the crown matrix 50. Whereas the sidewalls of the crown matrix 14 taper towards the gingival margin 45, rotating the crown matrix 14 about the hinged portion 56 into an open position will facilitate removal of the crown shell 12 from the crown matrix 14. Numbering used in identifying elements of the previously described preferred embodiments will be used to describe this preferred embodiment as well.

The buccal 38, lingual 40, distal 42 and mesial 44 surfaces of the crown matrix 14 are divided into upper and lower portions 38a,b, 40a,b, 42a,b, and 44a,b at margin 58. The margin 58 is a cut or separation that extends substantially around the circumference of the of the crown matrix 14, with the hinged portion 56 left un-cut. In this embodiment, the hinged portion 56 is a segment of the crown matrix 14 that enables a side wall of the crown matrix to fold about the un-cut portion or fold-line. In the preferred embodiment shown in FIGS. 7-9, the hinged portion 56 is located on the lingual surface 40 or buccal surface 38 of the crown matrix 14 to preserve correct spacing between distal and mesial surfaces on an adjacent tooth and crown.

A first and second locking portion 60a, 60b and corresponding receptacles 62a, 62b are disposed on the side wall opposite the hinged portion 56. In FIGS. 7-9 the locking portions and corresponding receptacles are located on the buccal surface 38 or lingual surface 40 of the crown matrix 14. In this preferred embodiment, the locking portions 60a, 60b are releasable, bobble-type cable ties. However, any suitable locking means can be utilized. Another feature displayed in this preferred embodiment is the cut-out portions 64, 66 in the distal 42a and mesial 44a surfaces of the crown matrix 14. Smaller indentations or cut-out portions 68, 70 are located in the distal 42b and mesial 44b surfaces of the crown matrix 14. The upper portion of the crown matrix 14 receives the crown shell 12.

As seen in the previous preferred embodiment, the crown matrix 14 further comprises one or more perforations or vents 52, 54 in the sidewall on the buccal portion 38 and/or lingual portion 40 of the crown-matrix 14. The perforations or vents 52, 54 enables excess bonding and filling agent to escape during installation of the crown 10. The perforations or vents 52, 54 also enable the dental professional to work any air bubbles out of the bonding and filling agent to ensure a maximum amount of bonding and filling agent per volume available is utilized.

In a third embodiment of the present invention shown in FIGS. 10-11, the crown matrix 14 includes a partial buccal 38, lingual 40, distal 42 and mesial 44 sidewall defining the internal cavity of the crown matrix 50 into which the crown shell 12 seats. The occlusal portion present in preferred embodiments discussed above is not present in this embodiment and is replaced by a first and second strap member 72, 74 that extends over the occlusal surface 16 of the crown shell 12. Whereas the sidewalls of the crown matrix 14 taper towards the gingival margin 45, limiting the height of the sidewalls to the margin 58 will facilitate removal of the crown shell 12 from the crown matrix 14 at the aperture defined by margin 58.

A first and second locking portion 60a, 60b are disposed at the ends of the straps 72, 74 and corresponding receptacles 62a, 62b are disposed on the buccal sidewall. In this preferred embodiment, the locking portions 60a, 60b are releasable, bobble-type cable ties. However, any suitable locking means can be utilized. Small indentations or cut-out portions 68, 70 are located in the distal 42 and mesial 44 surfaces of the crown matrix 14.

As seen in the previous preferred embodiments, the crown matrix 14 further comprises one or more perforations or vents 52, 54 in the sidewall on the buccal portion 38 and/or lingual portion 40 of the crown-matrix 14. The perforations or vents 52, 54 enables excess bonding and filling agent to escape during installation of the crown 10. The perforations or vents 52, 54 also enable the dental professional to work any air bubbles out of the bonding and filling agent to ensure a maximum amount of bonding and filling agent per volume available is utilized.

In the preferred embodiments of the present invention described herein, the crown matrix 14 is comprised of thin plastic or metal foil to enable a dental professional to easily trim the crown matrix 14 with scissors (or other implements) to a custom fit as seen in FIG. 5b. To accommodate this customization, the thickness of the crown matrix 14 is preferably 10 to 100 microns.

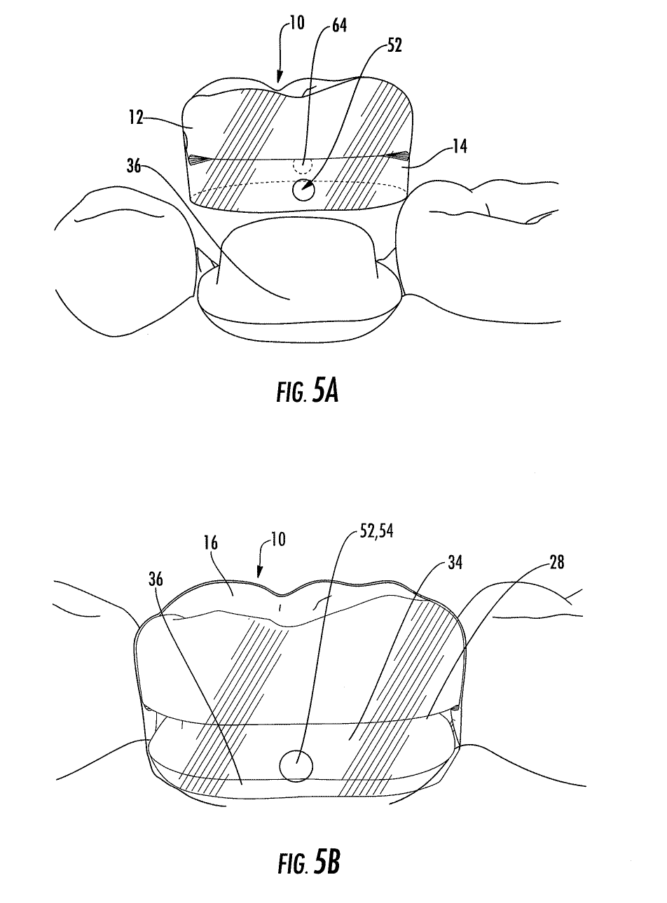

In practice, it is contemplated that a dental professional will obtain a kit comprising a set of crowns 10 including crown shells 12 and crown matrices 14 for multiple tooth anatomies and sizes and will choose the correct crown shell and crown matrix for each restoration. After selecting the appropriate crown shell 12 and crown matrix 14, the dental professional assembles the components to form a universal dental crown 10. As seen in FIG. 4, the cavity 26 of the crown shell 12 is filled with the bonding and filling agent which may consist of an auto-cured or light cured composite resin or cement 55. As seen in FIGS. 5a and 5b, the crown 10 is fitted onto the prepared tooth 36, ready to be pressed into place. Excess composite-resin or cement may escape through the 52, 54 in the sidewall on the buccal portion 38 and/or lingual portion 40 of the crown matrix 14, and is then removed and disposed of by the dentist (not shown). The dental professional trims the crown matrix 14 to fit (not shown). In FIG. 6, the crown matrix has been removed exposing the crown shell 12, hardened composite 55, and a portion of the prepared tooth 36. The crown matrix 14 may also remain in place as an extra barrier for protecting the crown shell 12. Whereas the crown shell 12 is now bonded to the prepared tooth 36, the restoration is complete. It is contemplated that the crown matrix could remain in place without compromising any functionality of the universal dental crown.

While the present invention has been described in connection with a specific application, this application is exemplary in nature and is not intended to be limiting on the possible applications of this invention. It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

I claim:

1. A dental crown for use in restoring a prepared tooth, the dental crown comprising:
a crown shell including a cavity for receiving a portion of the prepared tooth, sidewalls, and an apical margin defining the bottom edge of the sidewalls; and
a crown matrix including sidewalls defining an interior portion adapted to receive the crown shell and an exterior surface configured to resemble a tooth, wherein the sidewalls of the crown matrix extend beyond the apical margin of the crown shell.

2. The dental crown of claim 1 wherein the sidewalls of the crown matrix extend beyond the apical margin of the crown shell by at least approximately 1 to 4 millimeters.

3. The dental crown of claim 1 wherein the crown shell comprises a buccal surface, lingual surface, mesial surface and distal surface and an occlusal surface and wherein the crown matrix comprises a buccal, lingual, mesial, and distal sidewall, wherein said sidewalls define an interior cavity adapted to receive a portion of the crown shell.

4. The dental crown of claim 1 wherein the crown shell comprises a buccal surface, lingual surface, mesial surface and distal surface and an occlusal surface and wherein the crown matrix interior surface comprises a buccal portion, a lingual portion, a mesial portion, a distal portion, and an occlusal portion and the crown matrix receives the entire crown shell.

5. The dental crown of claim 1 wherein the crown matrix includes a perforation or thinned portion that enables tight fit of the dental crown with an adjacent tooth or adjacent crown.

6. The dental crown of claim 5 wherein the mesial surface of the crown matrix includes a perforation or thinned portion that enables tight fit of a mesial surface of the dental crown with a distal surface of an adjacent tooth or adjacent crown.

7. The dental crown of claim 5 wherein the distal surface of crown matrix includes a perforation or thinned portion that enables a tight fit of a distal surface of the dental crown with a mesial surface of an adjacent tooth or adjacent crown.

8. The dental crown of claim 1 wherein the crown matrix includes at least a first perforation or vent disposed in the sidewall in the portion extending beyond the apical margin of the crown shell, the perforation or vent facilitating escape of excess amounts of a bonding and filling agent used to affix the universal dental crown to the prepared tooth.

9. The dental crown of claim 1 wherein the crown matrix is formed from a trimmable material having a thickness between 10 and 100 microns.

10. The dental crown of claim 1 wherein the crown shell further comprises a distal extension portion and mesial extension portion.

11. The dental crown of claim 1 wherein the crown shell is received by the crown matrix and secured by friction fit.

12. The dental crown of claim 1 wherein the crown shell is received by the crown matrix and secured by adhesive.

13. The dental crown of claim 1 wherein the crown shell is releasably received by the crown matrix.

14. The dental crown of claim 1 wherein the crown matrix includes an upper and lower portion and hinged portion operatively connected to the upper and lower portions.

15. The dental crown of claim 14 wherein the crown matrix includes at least a first locking portion and a first receptacle disposed on a side wall of the crown matrix opposite the hinge portion.

16. The dental crown of claim 1 wherein the crown matrix includes at least a first strap member extending from a first sidewall to an opposing sidewall.

17. The dental crown of claim 16 wherein the first strap member terminates at a locking portion adapted to engage a corresponding receptacle disposed on the opposing sidewall.

18. A method of restoring a tooth with a dental crown, the method comprising the steps of:
a) preparing the tooth to be restored;
b) selecting a crown shell and a crown matrix, wherein the crown shell comprises an apical margin and a buccal surface, lingual surface, distal surface and mesial surface and wherein the crown matrix is dimensioned to extend beyond apical margin of the crown shell when the crown shell and crown matrix are fitted together;
c) fitting the crown shell and crown matrix together to form a dental crown;
d) providing a bonding and filling agent in a cavity in the dental crown;
e) fitting the dental crown on the prepared tooth; and

19. The method of claim 18 further including the step of trimming the crown matrix to fit.

20. The method of claim 18 wherein the step of selecting the crown shell and crown matrix includes selecting a crown shell to enable an occlusal surface of the crown shell to correspond with occlusal surfaces of adjacent teeth or crowns and to provide a gap between the apical margin of the crown shell and prepared tooth.

21. The method of claim 20 wherein the step of the fitting the dental crown on the prepared tooth further includes filling the gap between the apical margin of the crown shell and prepared tooth with the bonding and filling agent.

22. The method of claim 18 wherein the step of selecting the crown shell and the crown matrix includes selecting a crown matrix having a mesial portion and selecting a crown matrix having a perforation at the mesial portion to facilitate a tight fit of the dental crown with an adjacent tooth or dental crown.

23. The method of claim 18 wherein the step of selecting the crown shell and the crown matrix includes selecting a crown matrix having a distal portion and selecting a crown matrix having a perforation at the distal portion to facilitate a tight fit of the dental crown with an adjacent tooth or dental crown.

24. The method of claim 18 wherein the step of selecting the crown matrix and crown shell includes selecting a crown matrix including at least a first aperture to facilitate escape of excess bonding and filling agent during fitting of the dental crown onto the prepared tooth.

25. A kit for restoring a tooth, the kit comprising:
a plurality of crown shells, the crown shells having at least a first occlusal, buccal, lingual, mesial, and distal surface configuration, each crown shell further comprising an apical margin defining the bottom edge of the crown shell; and
a plurality of crown matrices comprising an exterior surface configured to resemble a tooth and further configured to receive the crown shell wherein sidewalls of the crown matrix extend beyond the apical margin of the crown shell
wherein a crown shell and crown matrix are fitted together to form a dental crown for restoring a prepared tooth.

26. The kit for restoring a tooth of claim 25 wherein the plurality of crown shells are in differing sizes.

27. The kit for restoring a tooth of claim 25 wherein the plurality of crown matrices are in differing sizes.
